(19) United States
(12) Patent Application Publication
(10) Pub. No.: US 2011/0145010 A1
(43) Pub. Date: Jun. 16, 2011

(54) DYNAMIC USER-DEFINABLE TEMPLATE FOR GROUP TEST

(75) Inventors: Leszek P. Rumak, Dunedin, FL (US); Karen MacLennan, Palm Harbor, FL (US); Bogdan Koszowski, Rzeszow (PL); Jacek A. Lech, Rzeszow (PL)

(73) Assignee: Soft Computer Consultants, Inc., Clearwater, FL (US)

(21) Appl. No.: 12/965,897

(22) Filed: Dec. 12, 2010

Related U.S. Application Data
(60) Provisional application No. 61/286,006, filed on Dec. 13, 2009.

(51) Int. Cl. G06Q 50/00

(52) U.S. Cl. 705/2

(57) ABSTRACT

An information processing system, a method and a computer-readable storage medium are provided. The information processing system can include instructions which are executable by the processor to perform a method which includes defining a template containing information usable to generate a computer-displayable table. The table can have collection prompts for collecting data which results from or is associated with medical testing. For example, the method can include defining each of a plurality of result elements for which data is to be collected based on input received from a user in response to a plurality of first prompts, and can include defining the names of result elements and types of input required in response to the collection prompts. Defining the template can further include defining at least one parameter for displaying the table in response to the collection prompts. In such way, the template can be used, for example, to restrict the collection of input according to the types of input required by the template.

### CROSS-REFERENCE TO RELATED APPLICATION

This application claims the benefit of the filing date of U.S. Provisional Application 61/286,006 filed Dec. 13, 2009, the disclosure of which is incorporated herein by reference.

### BACKGROUND OF THE INVENTION

1. Field of the Invention

The subject matter of the present application relates to medical information systems, and more specifically to a system for collecting, documenting and reporting results of medical testing.

2. Description of the Related Art

The particular requirements for conducting and documenting medical tests are standardized in some respects, but can vary in other respects. Each institution, i.e., a provider organization, for example, a professional practice, hospital, university, laboratory services company, etc., can have requirements, practices and procedures which vary from those of other institutions.

Medical, e.g., laboratory information systems typically include one or more computers which display forms on a screen for the entry of test data, and which generate and display reports containing the results of tests. Heretofore, medical or laboratory information systems have provided standardized forms for the entry, collection, and display of test data. However, standardized forms have not adequately served each institution's needs. Without the ability to alter the type of data collected on a form and how it is documented, some institutions have resorted to manual intervention by the computer user, for example, data entry operator, to meet institutional requirements. Unfortunately, manual intervention can lead to inconsistent documenting and reporting of test data. In addition, when manual intervention is required, efforts are required to train data entry personnel and monitor adherence to procedures to ensure that the data are entered properly by the prescribed manual intervention.

Further improvements in the collection, documenting and reporting of test data would be desirable.

### BRIEF DESCRIPTION OF THE DRAWINGS

FIG. 1 is a schematic diagram illustrating a medical information processing system in accordance with an embodiment of the invention.

FIG. 2 is a schematic diagram further illustrating a medical information processing system in accordance with an embodiment of the invention.

FIG. 3 depicts a screen used to define a template in accordance with an embodiment of the invention.

FIG. 4 depicts a screen used for entering results of a test in accordance with an embodiment of the invention.

FIG. 5 further depicts a screen used for entering results of a test in accordance with an embodiment of the invention.

FIG. 6 depicts a displayed report containing a table of data in accordance with an embodiment of the invention.

### SUMMARY OF THE INVENTION

An information processing system, a method and a computer-readable storage medium are provided. The information processing system can include instructions which are executable by the processor to perform a method which includes defining a template containing information usable to generate a computer-displayable table. The table can have collection prompts for collecting data which results from or is associated with medical testing. For example, the method can include defining each of a plurality of result elements for which data is to be collected based on input received from a user in response to a plurality of first prompts, and can include defining the names of result elements and types of input required in response to the collection prompts. Defining the template can further include defining at least one parameter for displaying the table in response to the collection prompts. In such way, the template can be used, for example, to restrict the collection of input according to the types of input required by the template.

The computer-readable storage medium can have a plurality of computer-readable instructions recorded thereon which are executable by a processor to perform a method such as described above in connection with the information processing system.

Another aspect of the invention is a method which includes using a computer in defining a template containing information usable to generate a computer-displayable table. The table can have collection prompts for collecting data which results from or is associated with medical testing. For example, the method can include using a computer in defining each of a plurality of result elements for which data is to be collected based on input received from a user in response to a plurality of first prompts, and can include defining the names of result elements and types of input required in response to the collection prompts. The step of using a computer in defining the template can further include defining at least one parameter for displaying the table in response to the collection prompts. In such way, the template can be used, for example, to restrict the collection of input according to the types of input required by the template.

### DETAILED DESCRIPTION

Accordingly, a medical information system and method are provided herein in which institutional requirements and procedures can be incorporated into the data entry and reporting processes. Using a system as provided herein, data can be collected and documented in accordance with institutional requirements and procedures without requiring manual intervention on the part of the user or data entry operator. In such way, the results of medical tests can be collected and documented in a consistent manner throughout an organization.

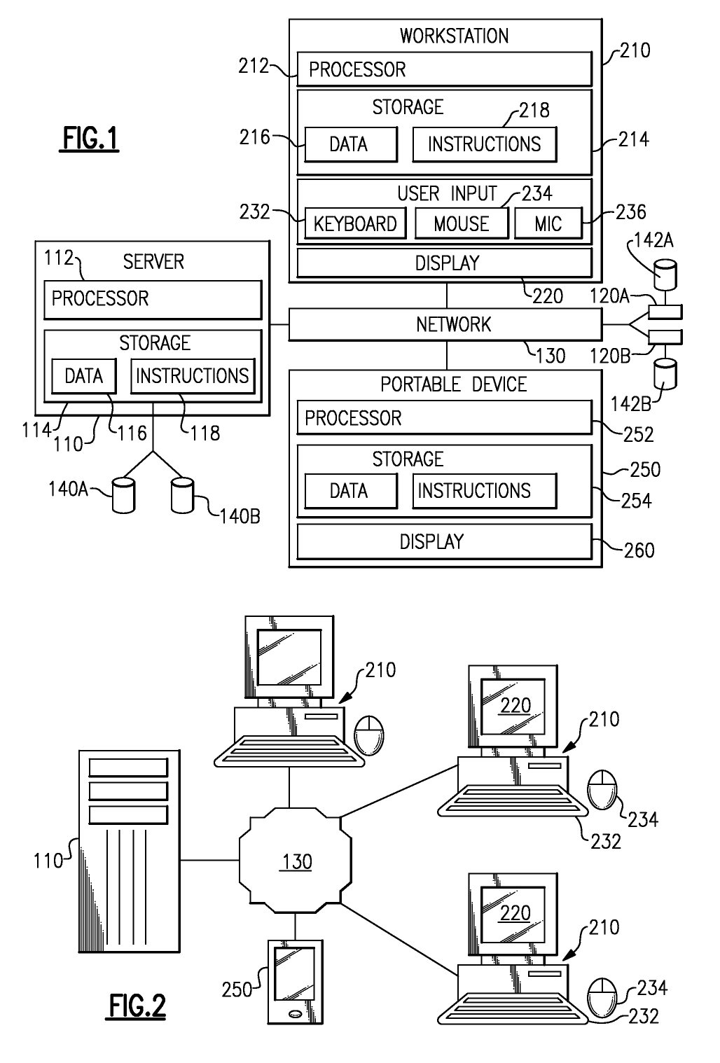

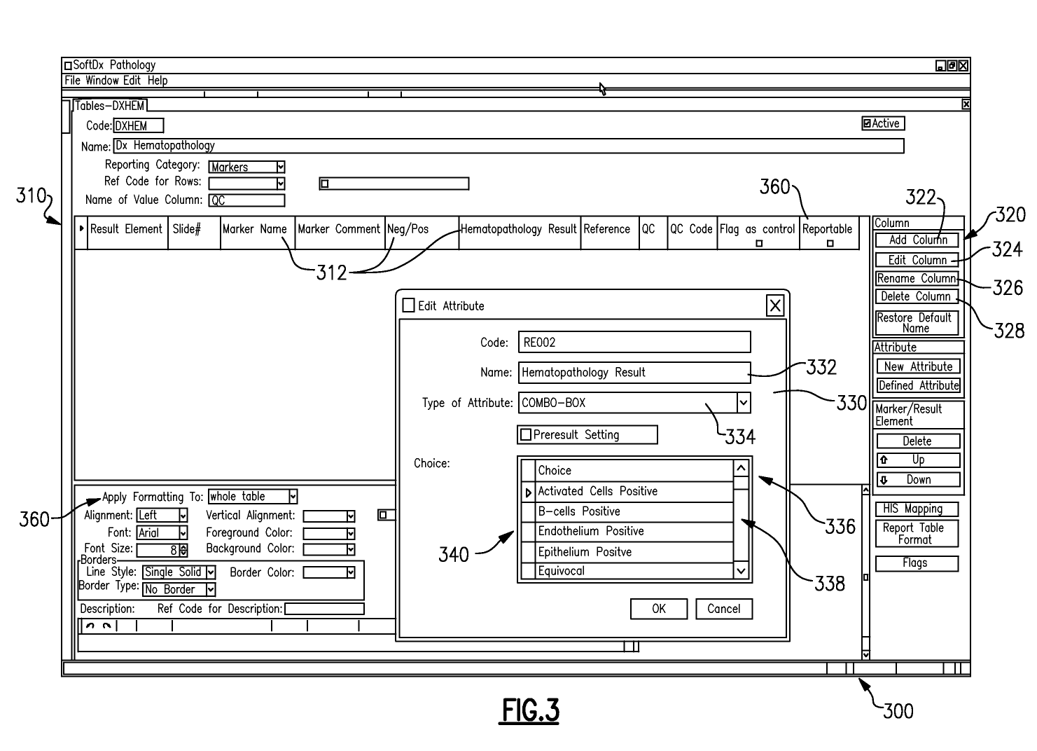

As shown in FIGS. 1 and 2, a medical information processing system can include a computer or information processing system 110, for example, a computer having a processor 112 that may include one or more microprocessors. The computer 110 may function as a server to serve data and instructions to other computers. Storage 114 is available for storing and retrieving information used by the processor. For example, storage 114 may be used to store data 116 and instructions 118 which are executable by the processor. Storage can include, for example, one or more of various magnetic, solid-state or optical drives, etc., for read-write access to data and instructions. The storage can also include one or more various portable memory media which can be read-write type, read-only type or combination type (e.g., a type of medium designed to be written only once but read many times), which can be recorded or read by electrical, magnetic, or optical means. For example, the storage can include an external memory drive or miniature memory card, e.g., SD card or drive, a compact disc (“CD”) or CD-ROM, digital versatile disc (“DVD”), magnetic tape media, etc., which are easily and readily interchangeable with other similar media, and on which data or instructions or both can be recorded, read and, in some cases, executed by computer 110. The server 110 can be connected to additional storage 140A, 140B, which can be locally connected thereto. The additional storage can house one or more repositories of data, e.g., sources of test data such as one or more databases which track orders of tests and the results which are produced by the tests.

The instructions 118 can be any instructions which are executable by the processor, such as machine language instructions, or can be in any computer language such as source code which is compiled in advance of execution or interpretable code which is interpreted during execution. The data can be handled, i.e., written to storage or retrieved therefrom or modified based on the execution of the instructions 118 by the processor. Although the storage 114 is shown together with processor 114 in computer 110, the storage may or may not be housed together with the processor in the same physical unit.

In one example, networking equipment 130 (hereinafter, “network”) can be used to facilitate communication between the computer 110 and a plurality of auxiliary servers 120A, 120B, to which additional databases can be accessed in storage 142A, 14B. The network can also connect the server with one or more workstations 210, as seen in FIG. 2. The three workstations 210 shown in FIG. 2 are merely illustrative, as there can be fewer or more workstations capable of connecting to a server 110 or to each other through a network 130. The network 130 can include one or more types of networks, such as, but not limited to: an enterprise network for the primary use or control by a particular organization, an intranet, i.e., a non-public network operating in accordance with the communication protocol known as Internet Protocol, or can be another type of a private or virtual private network, etc. The network 130 can include portions extending within a public network such as the Internet. In such case, provisions can be made for secure connections through the Internet to satisfy security and quality-of-service goals. Communications between nodes can be facilitated by any of a variety of network communication protocols, such as, without limitation, wired or wireless communication protocols.

Like computer 110, workstations 210 typically include a processor 212 (FIG. 1) and are capable of storing and retrieving data 216 and instructions 218 from associated storage 214 which may be housed together with the processor or separately therefrom. The workstation typically includes a display 220, e.g., a screen capable of electronically displaying still or moving images or both, which is capable of displaying information to a user in a form readable or recognizable by the user. Devices such as a keyboard 232 and a mouse 234, trackball or other pointing device typically are provided for registering user input. The display, keyboard, mouse (or both) can together facilitate inputting of user information through a graphical user interface (“GUI”) such as a Windows® operating system-enabled display (Windows is a registered trademark of Microsoft Corporation). For example, user input may be of a type which causes the display of information presented to the user at a particular location on the screen to be modified when the user selects the location using a mouse or other pointing device.

A portable computing device 250 (FIGS. 1-2), e.g., typically a handheld computer such as a personal digital assistant, e.g. Blackberry type device, or cellular phone type device, which may have a wireless interface or a wired (contact-based) interface may also be provided which can connect with computer 110 or a workstation 210 through network 130. Like computer 110, the portable device 250 can have a display 260 for presenting information to the user and typically has one or more of a keyboard (not shown) or keypad (not shown) and pointing device (not shown) for registering user input therewith. Like computer 110, portable device 250 has a processor 252 and storage 254 for the storage of instructions for execution by processor 252 to retrieve, store or modify data. Although some functions may be indicated below as being performed on a server and other functions may be indicated as being performed on a workstation, various aspects of a system and method may be implemented by a single computer. In a method according to an embodiment of the invention, a screen is displayed which allows a template to be defined for how the results of a medical test are to be documented. An information processing system, e.g., a computer, can execute a set of instructions which cause the screen to be displayed thereon. A set of instructions, e.g., a program may be recorded on a computer-readable medium. The instructions can be obtained, read or retrieved from the computer-readable medium and executed by a processor, e.g., a processor of a computer, to perform a method in accordance with an embodiment of the invention.

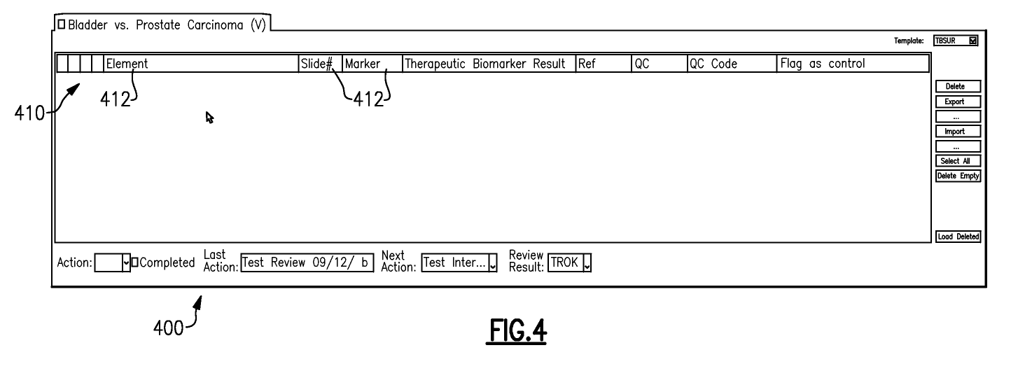

Referring to FIG. 3, an administrator or a privileged user of a medical information system, e.g., one having administrative privileges, can define the content of a set of columns to be displayed when collecting and documenting the results of a test or test panel. The screen permits the administrator to not only specify what data is to be collected, but also to select the particular kind of information, e.g., numeric, text, positive or negative result, etc., that is to be collected, and the format in which it is to be collected and documented.

FIG. 3 illustrates a screen 100 used to define a template which controls how results are to be documented when conducting a test panel, for example, a group of tests, such as for hematopathology. After defining the template, an administrator can select a test or panel, e.g., a group of tests, to be governed by the template. Once the template has been defined and an administrator has selected a type of test or panel which should use the template, the template will then control how the results of the selected test type will be collected, documented and displayed. The template will also control the appearance and function of a screen through which a user, e.g., a data entry operator enters the data.

For example, as seen in FIG. 3, the screen displays a table 110 having a plurality of columns 112. Each of the columns identifies a type of information to be collected or documented. The names of the columns are displayed at each column location: “Result Element,” “Slide#,” “Marker Name,” “Marker Comment,” “Neg/Pos,” “Hematopathology Result,” “Reference,” “QC,” “QC Code,” “Flag as Control,” and “Reportable”. In an embodiment, the location and name of each column of the table can be defined by an administrator. Moreover, an attribute, e.g., a particular characteristic of, or content of the column, can be defined by selection of the administrator or a definition entered by the administrator.

In the example seen in FIG. 3, the screen provides a set 120 of buttons which the administrator can use to manipulate the columns of the table. These buttons bear the names of the functions they perform: “Add Column” 122, “Edit Column” 124, “Rename Column” 126, and “Delete Column” 128. The process of defining a template may begin without any columns having been defined for entering test data. In one example, when the administrator needs to add a column to the table, the administrator can select the “Add Column” button 122 and a data entry menu can then appear on the screen.

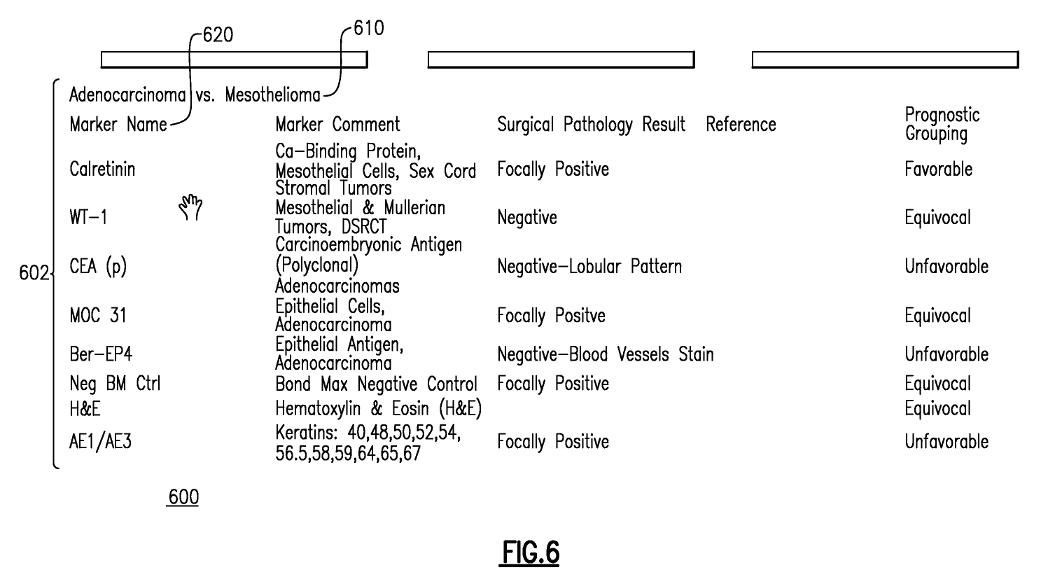

Alternatively, some column names can be part of an initial default setup for the template, but can allow for modification by the administrator. For example, certain columns such as “Result Element”, “Slide#”, “Marker Name” and others may be part of an initial default setup for the template. “Result Element”, for example, can identify a particular result to be collected when conducting a panel of tests. As one example, a peripheral blood test can include a Result Element for red blood cell count, another Result Element for T-cell count, and various other Result Elements for other peripheral blood components. As will be described in further detail below (FIG. 5), a plurality of different Result Elements of a panel and the data corresponding thereto can be arranged and displayed in separate rows of a table.

The process of defining a column and the corresponding data to be collected at each column can be performed by administrator input to the screen 110. For example, as seen in FIG. 3, when the administrator is defining the data to be collected for a column, a drop-down menu 130 having a caption “Edit Attribute” can be presented. The menu can provide an input location “Name” 132 for the administrator to define the name of the column. Another input location “Type of Attribute” 134 allows the administrator to define the type of input to be collected from a user, such as a data entry operator, when documenting results of a test. For example, in this example, the administrator has defined the name of one column of data as “Hematopathology Result”. If the administrator needs to change the name of the column, the administrator can input a different name at location 132. The “Type of Attribute” location 134 can provide several choices for the administrator to select when defining the type of input expected from the data entry operator. For example, the administrator can choose the type of expected input data from among: numeric, free text, checkbox, negative or positive result, or selection from multiple choices—i.e., a “pick-list” or “COMBO-BOX” 136. By selecting COMBO-BOX, the administrator can set up the template to require the data entry operator to select input from a list of defined choices. In addition, the administrator can define what each choice is, and what choices will appear on the list. For example, in the drop-down menu 130 the pick-list can display a box 136 selected or defined by the administrator which displays the choices of: “Activated Cells Positive”, “B-cells Positive”, “Endothelium Positive”, “Epithelium Positive” and “Equivocal”, among others. In one example, the pick-list can display several choices with checkboxes which permit or require the data entry operator to select whether particular choices listed on the display are found in the results of the test. The pick-list may include one or more other choices which do not currently appear in the location 136 on the screen but which can be displayed when the administrator scrolls the location using scroll function 138 to display the one or more other choices.

In one embodiment, the choices which appear on the pick-list can be predefined for a particular type of test or test panel. In such case, the administrator can select a pre-defined pick-list corresponding to a particular type of test or panel, and the pick-list will then become part of the template. In a particular embodiment, if the administrator needs to change the pick-list, the administrator can add another choice to the list, delete one of the choices from the list, or alter the name of a choice which is on the list.

In some cases, the administrator can define a column of the table to contain data imported or retrieved from a data base or data which is calculated from other data. For example, the administrator can define a column to retrieve information from the data base that relates to the patient for whom the panel test is performed. Using prompts and buttons on the displayed screen 100, the administrator can select the particular information to be retrieved by the template from the data base. In one embodiment, the administrator can select data which may be inputted automatically to the data base when using automated test equipment to perform a test. As additional examples of the types of information that can be retrieved, the administrator can use the functions available on the screen 100 to arrange the template to retrieve information identifying the patient, or to retrieve information about the patient, e.g., age, sex, ethnicity, present or past diagnosis, etc. Some of these types of data can be imported from the data base based on the type of data that the administrator defines for the column.

The administrator can also use the screen 100 to define a particular column which contains calculated data. The data in such column can be calculated based on a test result entered by a user based on test data imported from a data base, or both. In one embodiment, the administrator can select the data on which to perform the calculation and can select the particular calculation to be performed. For example, when conducting a panel test relating to kidney function of a patient, the administrator can define columns to contain the actual levels of serum components determined by the test, and can define other columns to indicate results of whether each serum component is within, above, or below a target range for normal kidney function.

One of the aspects of this embodiment is that the administrator can use the template to choose which serum components are important and should be calculated, and determine which columns of data will be listed on a test report, e.g., as seen in FIG. 6 described below. For example, as seen at column 160 on screen 110, the administrator has the option of making the data for a particular column reportable or not. For example, for this purpose column 160 can include a checkbox for the administrator to mark. When the column is checked as “reportable”, the data that is defined by the column is reported with results of the test in the report. However, when the column is not checked as “reportable”, the data defined by the particular column is not reported with results of the test in the report. In this way, the administrator can arrange the template to permit the data entry operator to view the test results in a view such as on an in-progress screen, e.g., as seen in FIG. 5. However, the template can avoid having to provide all the same data when generating a report concerning the test.

In one particular embodiment, the administrator can use screen 100 to define a column of the template to provide a calculated result. In one example, such calculated result may include comparing a result of a test of the current order with the result of another test, or even calculating a difference between the result of the test of the current order and the other test. For example, in such embodiment, the administrator can define a column to indicate the difference in a blood cholesterol level between the level determined in a test of the current order and the level that is determined in the other test. In a particular example, both the test and the other test are in the same current order of tests. In another example, such calculated result may include retrieving a result from a prior test, comparing a result of the present test with the prior test, or even calculating a difference between the result of the present test and the prior test. For example, in such embodiment, the administrator can define a column to indicate the difference in a blood cholesterol level between the level determined in the present test and the level that was determined in the prior test.

As further seen in FIG. 3, screen 100 further includes a portion 150 which permits the administrator to determine formatting to be used when generating a report (FIG. 6) in accordance with the template. Portion 150 allows the administrator to select a font, colors used for the font and the background, shading and formatting of columns or rows, alignment of characters, borders, and other options, for example.

The above description pertains to the definition of a template for use in determining the data to be collected and documented when conducting a test or panel of tests. After defining a template, the administrator can select a test or panel of tests, e.g., a “group test”, whose results will be documented and reported in accordance with the template.

After a template is defined and associated with a particular test or panel, the medical information system can now be used to collect and document data when conducting such test or panel.

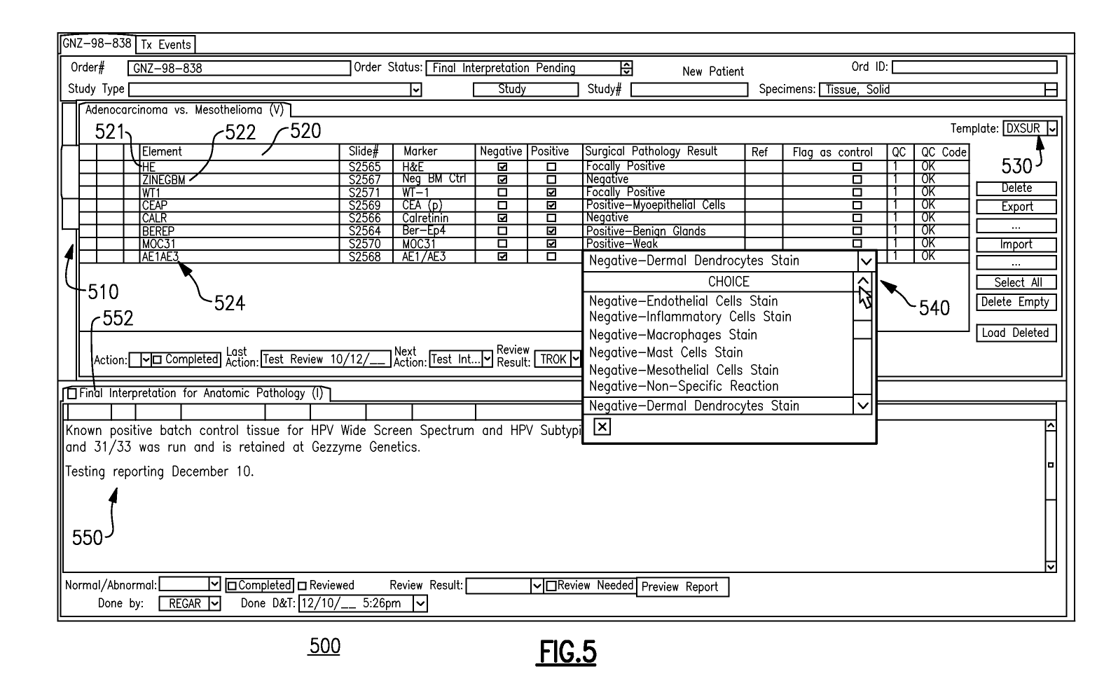

FIG. 4 illustrates a screen 200 that can be displayed when a user (e.g., a data entry operator) of the medical information system enters results of performing a particular test. FIG. 4 illustrates the screen 200 at the beginning of a test, prior to test results having been documented. Accordingly, at this stage, the screen 200 can display column headers 212 of a table 220, the headers having names as defined by the template. Specifically, the screen 200 displays the column headers of the table in a form arranged by the administrator when defining the template as described above. As seen in FIG. 4, no test results are yet recorded on the table, there being no rows below the column headers 212.

FIG. 5 illustrates a screen 300 similar to screen 200 (FIG. 4). Like screen 200, screen 300 can be displayed when the user, e.g., data entry operator, enters data concerning results of performing a panel of tests. However, screen 300 shows a stage after several Result Elements have been documented. As seen in FIG. 5, each different Result Element can be documented in a different row of a displayed table 310. For example, a row 321 displays the Result Element for “HE” and a row 322 displays a Result Element for “Z1NEGBM”. The table can become populated with a row for each Result Element after each component of a panel has been performed and is ready for the user to enter data for such Result Element. FIG. 5 shows a stage after several components of the panel have been performed and are ready for data entry.

As seen in FIG. 5, the columns displayed in the table for each Result Element are controlled in accordance with a selected template, which in this case, is identified as “DXSUR” at screen location 330. In each row, the column definitions provided by the template can control the type of data that can be inputted by the user, e.g., the person providing data input. For example, as seen in FIG. 5, the columns include a checkbox for “Negative” and another checkbox for “Positive”. In a particular embodiment, these column definitions can be arranged such that if the user marks the checkbox in the Negative column for a Result Element, any mark that is in the checkbox in the Positive column for the same Result Element will become unmarked, and vice versa.

FIG. 5 illustrates a particular example in which the user is about to enter a result for the Result Element identified as “AE1AE3” 324 in column 320. At this stage, a pick-list 340 is displayed in accordance with the previously defined column definition. The user will now select a choice listed in the template-defined pick-list for that Result Element (AE1AE3). FIG. 5 also illustrates entry of free text in a text entry window 350 provided on the screen. As seen in FIG. 5, in one example the user can enter such text as part of comments about the final test results in a field identified as “Final Interpretation for Anatomic Pathology” 352.

FIG. 6 illustrates a report 400 containing a table 402. The table contains test results as collected and documented in accordance with a template as described above. The report 400 can correspond to a panel of tests being documented as described above with reference to FIG. 5. The title 410 “Adenocarcinoma vs. Mesothelioma” of the table 402 can be as defined in such template. In addition, the particular columns which are displayed can be limited to columns which are selected by the template as being “Reportable”. Columns which are not marked as “Reportable” on the template can be left out of the report 400. The template can also control the names of the column headers 420, such as “Marker Name,” “Marker Comment,” “Surgical Pathology Result,” and the type of data to be listed on the report. In addition, the formatting of the table, e.g., the font, background, column widths, borders, any shading applied thereto, etc., can be as controlled in accordance with the template.

While the invention has been described in accordance with certain preferred embodiments thereof, those skilled in the art will understand the many modifications and enhancements which can be made thereto without departing from the true scope and spirit of the invention, which is limited only by the claims appended below.

1. An information processing system, comprising a processor, and instructions executable by the processor to perform a method comprising:
defining a template containing information usable to generate a computer-displayable table having collection prompts for collecting data resulting from or associated with medical testing, including defining each of a plurality of result elements for which data is to be collected based on input received from a user in response to a plurality of first prompts, and including defining names of result elements and types of input required in response to the collection prompts, and defining at least one parameter for displaying the table in response to the collection prompts,
wherein the template is usable to restrict the collection of input according to the types of input required by the template.

2. The information processing system as claimed in claim 1, wherein the method further comprises, associating the template with at least one medical test based on input received after defining the template, such that the template then is usable to collect data resulting from or associated with the at least one medical test.

3. The information processing system as claimed in claim 1, wherein the step of defining the template includes renaming a column of the computer-displayable table.

4. The information processing system as claimed in claim 1, wherein the step of defining the template includes at least one of adding, deleting or editing a column of the computer-displayable table.

5. The information processing system as claimed in claim 1, wherein the step of defining the template includes at least one of adding or editing the column, and the at least one of adding or editing the column includes defining an attribute of the column based on received input.

6. The information processing system as claimed in claim 1, wherein the step of defining the template includes defining results inputs to be received for first and second tests, and. based on received input, defining a comparison to be made between the results inputs regarding the first and second tests to form a comparison definition, wherein the template is usable to perform the comparison according to the comparison definition.

7. The information processing system as claimed in claim 1, wherein the step of defining the template includes recording in response to received user input when a result to be collected according to the computer-displayable table is not reportable, wherein the template is usable to restrict the generation of a report to results other than results which are recorded as being not reportable.

8. The information processing system as claimed in claim 1, wherein the step of defining the template includes defining a calculation to be performed on the data to be collected regarding the medical test, and defining a format for displaying a result of the calculation.

9. The information processing system as claimed in claim 8, wherein the step of defining the calculation includes defining a comparison between a result of the medical testing and a target parameter, and the step of defining a format for displaying the result defines an indication for displaying whether the result of the comparison meets or does not meet the target parameter.

10. A computer-readable storage medium having instructions recorded thereon which are executable by a processor to perform a method, the method comprising:
defining a template containing information usable to generate a computer-displayable table having collection prompts for collecting data resulting from or associated with medical testing, including defining each of a plurality of result elements for which data is to be collected based on input received from a user in response to a plurality of first prompts, and including defining names of result elements and types of input required in response to the collection prompts, and defining at least one parameter for displaying the table in response to the collection prompts,
wherein the template is usable to restrict the collection of input according to the types of input required by the template.

11. The computer-readable storage medium as claimed in claim 10, wherein the method further comprises, associating the template with at least one medical test based on input received after defining the template, such that the template then is usable to collect data resulting from or associated with the at least one medical test.

12. The computer-readable storage medium as claimed in claim 10, wherein the step of defining the template includes at least one of adding, deleting or editing a column of the computer-displayable table.

13. The computer-readable storage medium as claimed in claim 10, wherein the step of defining the template includes at least one of adding or editing the column, and the at least one of adding or editing the column includes defining an attribute of the column based on received input.

14. The computer-readable storage medium as claimed in claim 10, wherein the step of defining the template includes defining results inputs to be received for first and second tests, and. based on received input, defining a comparison to be made between the results inputs regarding the first and second tests to form a comparison definition, wherein the template is usable to perform the comparison according to the comparison definition.

15. The computer-readable storage medium as claimed in claim 10, wherein the step of defining the template includes recording in response to received user input when a result to be collected according to the computer-displayable table is not reportable, wherein the template is usable to restrict the generation of a report to results other than results which are recorded as being not reportable.

16. The computer-readable storage medium as claimed in claim 10, wherein the step of defining the template includes defining a calculation to be performed on the data to be collected regarding the medical test, and defining a format for displaying a result of the calculation.

17. A method, comprising:
using a computer in defining a template containing information usable to generate a computer-displayable table having collection prompts for collecting data resulting from or associated with medical testing, including defining each of a plurality of result elements for which data is to be collected based on input received from a user in response to a plurality of first prompts, and including defining names of result elements and types of input required in response to the collection prompts, and defining at least one parameter for displaying the table in response to the collection prompts,
wherein the template is usable to restrict the collection of input according to the types of input required by the template.

18. The method as claimed in claim 17, wherein the method further comprises, using a computer in associating the template with at least one medical test based on input received after defining the template, such that the template then is usable to collect data resulting from or associated with the at least one medical test.

19. The method as claimed in claim 17, wherein the step of using a computer in defining the template includes at least one of adding or editing the column, and the at least one of adding or editing the column includes defining an attribute of the column based on received input.

20. The method as claimed in claim 17, wherein the step of using a computer in defining the template includes defining results inputs to be received for first and second tests, and. based on received input, defining a comparison to be made between the results inputs regarding the first and second tests to form a comparison definition, wherein the template is usable to perform the comparison according to the comparison definition.
